(19) United States
(12) Patent Application Publication
(10) Pub. No.: US 2026/0313072 A1
(43) Pub. Date: Oct. 8, 2026

(54) SYSTEMS, DEVICES, AND METHODS FOR LIVE-STREAMING VIDEO AND AUDIO

(71) Applicant: Radovan Radenkovic, Highland, IN (US)

(72) Inventor: Radovan Radenkovic, Highland, IN (US)

(21) Appl. No.: 19/713,188

(22) Filed: Jun. 18, 2026

Related U.S. Application Data
(62) Division of application No. 18/589,887, filed on Feb. 28, 2024.
(60) Provisional application No. 63/487,478, filed on Feb. 28, 2023.
(60) Provisional application No. 63/608,861, filed on Dec. 12, 2023.

(51) Int. Cl. H04N 7/15

(52) U.S. Cl. CPC H04N 7/155; H04N 7/152

(57) ABSTRACT

Systems, devices, and methods for live-streaming video and audio. A system of live-streaming video and audio to a smartphone includes one or more cameras, microphones, and speakers coupled to a portable article for generating video and audio, a smartphone modified with hardware that controls the one or more cameras, microphones, and speakers, and a non-transitory memory storing an app and instructions on the smartphone. The app operates on the smartphone and accesses the non-transitory memory to provide inputs to the hardware for controlling the one or more cameras, microphones, and speakers to receive, store, and display the video and to receive, store, and broadcast the audio. To schedule a videoconferencing session, the observer selects an available time slot of the user (or vice versa) on the host site and pays the asking price to reserve the time slot.

### CROSS-REFERENCE TO RELATED APPLICATIONS

This is a division patent application of co-pending U.S. patent application Ser. No. 18/589,887 filed Feb. 28, 2024, which claims priority to U.S. Provisional Application No. 63/487,478 filed Feb. 28, 2023, and priority to U.S. Provisional Application No. 63/608,861 filed Dec. 12, 2023. The contents of these prior applications are incorporated herein by reference in their entireties.

### BACKGROUND OF THE INVENTION

The present invention generally relates to systems, devices, and methods for live-streaming video and audio.

Live stream videoconferencing between two or more people is an important tool for connecting people who are remote from each other for any of a near infinite number of reasons. In addition to standard conversation communication, live stream videoconferencing can also be used to connect a person with knowledge or a particular experience with another person who wishes to benefit from the other's knowledge or experience, such as teachers and students, trainees and experienced professionals, and celebrities and their fans. However, until now, it has been difficult for the person providing the desired knowledge or experience to get paid for his/her time directly from the person(s) wishing to receive the benefit of the knowledge or experience.

Therefore, it would be desirable to have a system, device(s), and/or method to allow a person with a desirable knowledge and/or experience to easily connect with other persons who wish to benefit from that knowledge or experience remotely. It would also be desirable for the person providing the knowledge and/or experience to be easily renumerated for sharing his/her time with the persons who wish to benefit therefrom.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, a system of live-streaming video and audio to a smartphone, a system of live-streaming video and audio, and a method of live-streaming video and audio data between a user and an observer.

According to one nonlimiting aspect, a system of live-streaming video and audio to a smartphone includes one or more cameras, microphones, and speakers coupled to a portable article for generating video and audio, a smartphone modified with hardware that controls the one or more cameras, microphones, and speakers, and a non-transitory memory storing an app and instructions on the smartphone. The app operates on the smartphone and accesses the non-transitory memory to provide inputs to the hardware for controlling the one or more cameras, microphones, and speakers to receive, store, and display the video and to receive, store, and broadcast the audio.

According to another nonlimiting aspect, a system of live-streaming video and audio includes a mobile audio-visual (AV) device having a frame, a camera carried by the frame, a microphone carried by the frame, and a speaker carried by the frame. A data communication link is configured for connecting the camera, microphone, and speaker with a mobile telecommunications device. The data communication link transmits user audio data and user video data captured by the camera and the microphone to the mobile telecommunications device and transmits observer audio data from the mobile telecommunications device to the speaker.

According to still another nonlimiting aspect, a method of live-streaming video and audio data between a first member and a second member is provided. The first member creates an available time slot on a host site and sets an asking price for the available time slot. The second member selects the available time slot on the host site and pays the asking price to reserve the time slot. During the reserved time slot, a streaming videoconference session is established between a mobile AV device associated with one of the first and second members as a user and a second AV device associated with the other of the first and second members as an observer via the host site. When the reserved time slot is complete, the streaming videoconference session ends.

Technical aspects of systems, devices, and methods having features as described above preferably include the ability to provide a convenient way to connect persons having specialized knowledge or experience with other persons hoping to benefit from that specialized knowledge or experience, and/or provide a system that allows a person to be easily renumerated for sharing specialized knowledge or experience with another person over a livestream videoconferencing session.

These and other aspects, arrangements, features, and/or technical effects will become apparent upon detailed inspection of the figures and the following description.

### BRIEF DESCRIPTION OF THE DRAWINGS

FIG. 1 is a schematic representation of a video conferencing system for remotely connecting a user and an observer according to certain non-limiting aspects of the invention.

FIG. 2 is a front view of a mobile telephone with a screenshot of a software application that controls a mobile audio-visual (“AV”) device for the user of the video conferencing system.

FIG. 3 illustrates an observer receiving an audio-video stream from the user.

FIG. 4 is a schematic representation of a first embodiment of a mobile AV device for use by the user.

FIG. 5 is an isometric view of a non-limiting example configuration of the mobile AV device according to the first embodiment.

FIG. 6 is a schematic representation of a second embodiment of a mobile AV device for use by the user.

FIG. 7 is an isometric view of a non-limiting example configuration of the mobile AV device according to the second embodiment.

FIG. 8 is a schematic representation of a third embodiment of a mobile AV device for use by the user.

FIG. 9 is an isometric view of a non-limiting example configuration of the mobile AV device according to the third embodiment.

FIG. 10 illustrates different example realizations of the mobile AV device according to any one of the embodiments configured as a wearable device configured to provide a video aligned along the point of view from the user.

FIG. 11 illustrates different example realizations of the mobile AV device according to any one of the embodiments configured as a mounted device to be supported from a stationary support.

FIGS. 12A and 12B are front and rear side views, respectively, of a non-limiting example configuration of the mobile AV device according to a fourth embodiment.

FIG. 13 illustrates steps in a method of live-streaming video and audio data between a user and an observer according to certain non-limiting aspects of the invention.

FIGS. 14A-14L are various screen shots encountered by member users and member observers of the video conferencing system during an example use scenario according to certain non-limiting aspects of the invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) depicted in the drawings and/or to which the drawings relate. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded at least provisionally to be aspects of the invention, including certain but not necessarily all of the aspects and alternatives described in the detailed description.

Although the invention will be described hereinafter in reference to various wearable and supported mobile AV devices shown in the drawings, it will be appreciated that the teachings of the invention are more generally applicable to a variety of types of AV devices other than those shown in the drawings.

A videoconferencing system (“platform”) is disclosed herein that, in some nonlimiting, non-exclusive configurations, creates a service for someone to sell their time, view, or experience, etc. to one or more other people by using live streaming audio/video communication for connecting one or more people. Such connections could be person to person, person to group, or group to group. The system makes it possible for a remote viewer (e.g., an observer) to see the view of someone (e.g., a user) and communicate with that person as a renumerated service. In one foreseeable use scenario, a content producer (“seller”) list's available time periods, offered service, and pay rate (set price). The observer (“customer”) can then select, pay for, connect, and optionally interact with the user during the purchased time period. Without being bound to any particular usage scenarios, it is foreseen that such a platform could be useful to put someone in contact with a mentor, hero, or source of inspiration remotely and in real-time. Some anticipated use examples include at least the following example use scenarios. An inexperienced person can seek the help of an experienced professional and pay for time and guidance. For example, a veteran laborer could get paid to watch and teach a less experienced professional while working, teaching a less experienced person anywhere in the world on the fly in real world applications and overseeing and troubleshooting using his/her acquired experiential knowledge and skill sets. In another possible scenario, a handicapped person with experience and knowledge in a physically active profession to which he/she can no longer participate can be paid to advise a live stream connection as a customer works in the same profession. In yet another possible scenario, in the situation where a medical emergency happens and there is no suitable medical professional there to help, such as an injury, pregnancy, or surgical procedure in a remote or inaccessible location, the system may be used to allow an experienced medical professional at a different location to guide an inexperienced person at the location of the emergency to take the necessary actions to address the medical emergency. In another possible scenario, an artist could use the system to pay their favorite artist to collaborate with or obtain advice during the creative process or audit the artistic work. In yet a further possible scenario the system to be used to allow a fan to connect with the person they idolize, such as a celebrity, athlete, musician, politician, explorer, etc., by booking time to talk with the person and/or watch as the person performs some activity. The system allows the user (e.g., a content producer such as a celebrity, experienced professional, teacher, artist, etc.) to remotely connect with others who wish to benefit from their time and/or experience and get paid for their time, and simultaneously allows the observer (e.g., a content consumer such as fan, less experienced professional, student, etc.) to remotely connect with and benefit from the experience of the content producer. In other scenarios, the user may be the one receiving instructions or guidance from the observer.

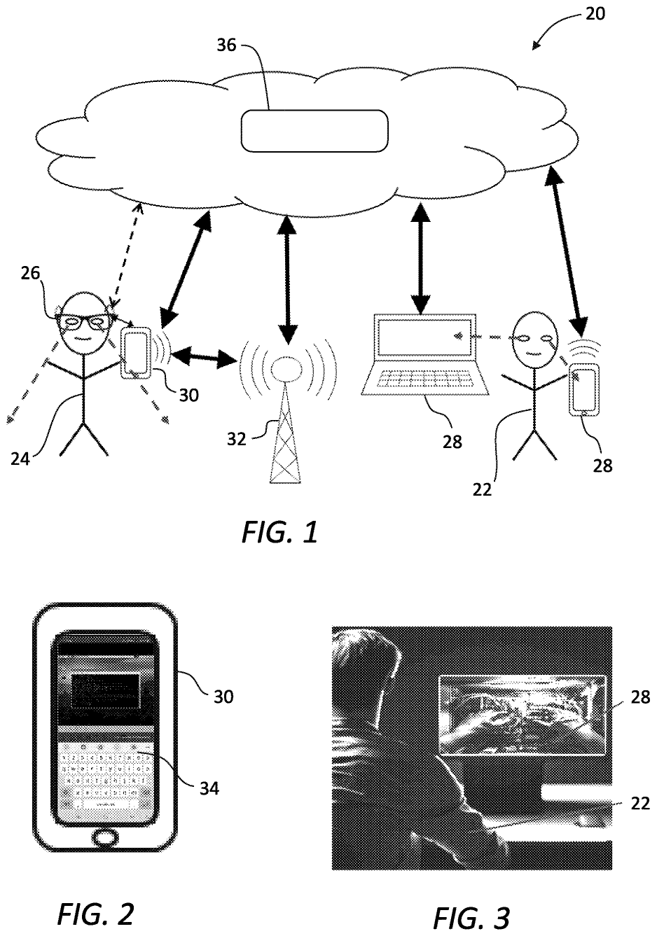

Turning now to the drawings, FIG. 1 schematically illustrates a video conferencing system 20, in which a member of the system 20, referred to herein as an “observer member” 24 or simply an “observer” 22, is able to connect with another member of the system 20, referred to herein as a “user member” 24 or simply a “user” 24, through a host site with a remote software application 36 such that the observer 22 is able to see and/or hear the video and/or audio being experienced by the user 24, and optionally talk with the user, in real time during a pre-defined reserved time slot agreed to between the user and the observer ahead of time. The user 24 uses a mobile audio-visual (AV) device 26 to stream a live video and/or audio feed to the user's AV device 28 via the software application 36 located in the “cloud” on one or more remote host computers connected to the internet. The mobile AV device 26 connects to the software application 36 via a first internet connection, and the users AV device 28 connects to the software application 36 via a second internet connection. The software application 36 is configured to allow the user 24 to offer one or more predetermined time slots during which one or more observers 22 can receive a live stream of video and/or audio from the mobile AV device 26 for a predefined amount of value (e.g., monetary price) set by the user 24. One or more observers 22 can then purchase one or more of the time slots offered by the user 24 for the predefined price to reserve the time slot(s). As shown for example in FIG. 3, during the purchased time slot(s), the observer 22 can access the audio and/or video stream from the mobile AV device 26 on the user's AV device 28 via the host cloud-based software application 36 of. The user 24 may choose to allow the observer 22 to also be able to interact directly with the user during the time slot by allowing the observer 22 also to send at least an audio data stream back to the mobile AV device 26 through the software application 36 and corresponding data communication links. At the end of the purchased time slot, the user's AV device 28 loses access to the live audio video stream from the mobile AV device 26, unless the observer 22 purchases an additional time slot (if such an additional time slot is offered by the user 24). In this manner, the videoconferencing system 20 provides a new way for a user to offer and obtain payment for access to audio and/or video streaming during predefined time slots that can be accessed by a single observer or by many observers, thereby facilitating the offer, purchase, and payment for live streaming AV streams in a manner that allows the user and the observer to more readily arrange such a transaction. In some non-limiting scenarios, the user may be a content producer, such as an artist or celebrity or teacher, or the user may be a receiver of guidance, such as a student or mechanic. Similarly, in some use scenarios, the observer 22 may be a content consumer, such as a fan or student, or a guidance provider, such as a teacher or guide. Of course, the user 24 and the observer 22 may take other roles. Without being bound to any specific example or type of utilization, it is believed that the videoconferencing system 20 may have beneficial uses at least in the areas of education, training, industrial operations, maintenance and repair operations, medical procedures, and entertainment. However, it is understood that the videoconferencing system 20 could be used in an essentially unlimited number of different types of uses and areas of human endeavor.

The user's AV device 28 may connect to the internet via any suitable type of connection, such as a hardwired connection, a wireless connection such as Bluetooth or Wi-Fi, or a wireless telecommunications connection. The mobile AV device 26 preferably has a wireless connection to the internet, such as via a Bluetooth, Wi-Fi, and/or wireless telecommunications connection (e.g., cellular telephony) so that the mobile AV device 26 can be easily moved around while streaming AV content to the software application 36 via the internet. As described in further detail hereinafter, the mobile AV device 26 may include necessary components connecting directly to the internet, or the mobile AV device 26 may be in data communication with a mobile telecommunications device 30, such as a mobile telephone, having the necessary computer hardware and software applications (“apps”) to relay AV data from the mobile AV device 26 to the internet and on to the software application 36, for example via Bluetooth, Wi-Fi, and/or a cellular telecommunications network 32.

In some embodiments, the mobile telecommunications device 30 is a smart phone loaded with an app configured to control the mobile AV device 26. As best seen in FIG. 2, the app displays one or more command screens 34 on the smart phone screen through which the user 24 (or another user) can send commands to various electronic audio-video components carried on the mobile AV device 26. In addition, the app can interact with the software application 36 on the host server in the cloud to allow the user 24 to control his/her account features on the software application 36. Thus, in a preferred configuration, the user 24 can control all aspects of the mobile AV device 26 and the users account on the software application 36 through the app executed on the mobile telephone 30.

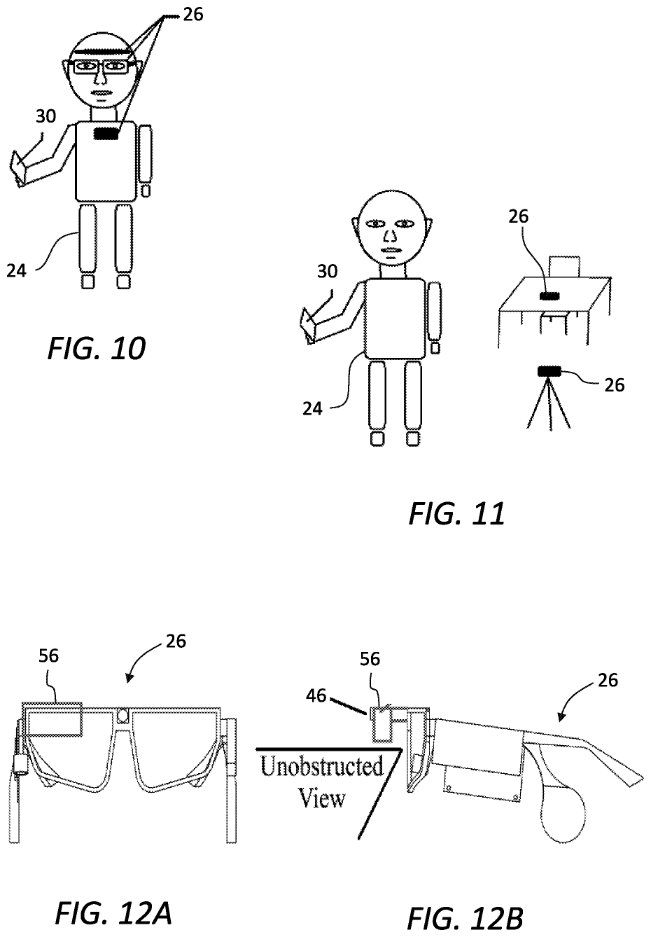

The mobile AV device 26 may have different form factors for different intended applications. For example, as schematically illustrated in FIG. 10, the mobile AV device 26 may be provided in the form of a wearable AV device, such as eyeglasses, a headset, a body cam, or other similar form-factor that is easily worn by the user and used during normal activity. In another example, as schematically illustrated in FIG. 11, the mobile AV device 26 may be provided in the form of a mounted AV device, such as a standalone device configured to mount on a desktop, webcam, tripod, automobile, or other (relatively non-mobile) support structure.

In operation, the mobile AV device 26 is turned on and connected to the mobile phone 30 and the internet. The control software app on the mobile phone 30 is opened and used to control the mobile AV device 26, such as by turning on or off the various AV components (e.g., camera(s), microphone(s), and/or speakers(s)) and to start and stop a live-stream AV feed to the software application 36 on the cloud host computer(s). The control software app may also optionally be used to control the software application 36. The control software app on the phone 30 shows a display page on the phone's screen. The control software app in some embodiments displays a virtual keyboard and mouse and can do everything a personal computer can do to allow live streaming video, point of view video calling, and one-way or bi-directional audio. The control software app on the smartphone may be configured remotely control a mouse and keyboard of a personal computer, receive and display the video from the mobile AC device on a display of the smartphone, and/or broadcast the audio from the mobile AV device and/or the user's AV device 28 over a speaker of the smartphone 30. However, other control configurations may be used.

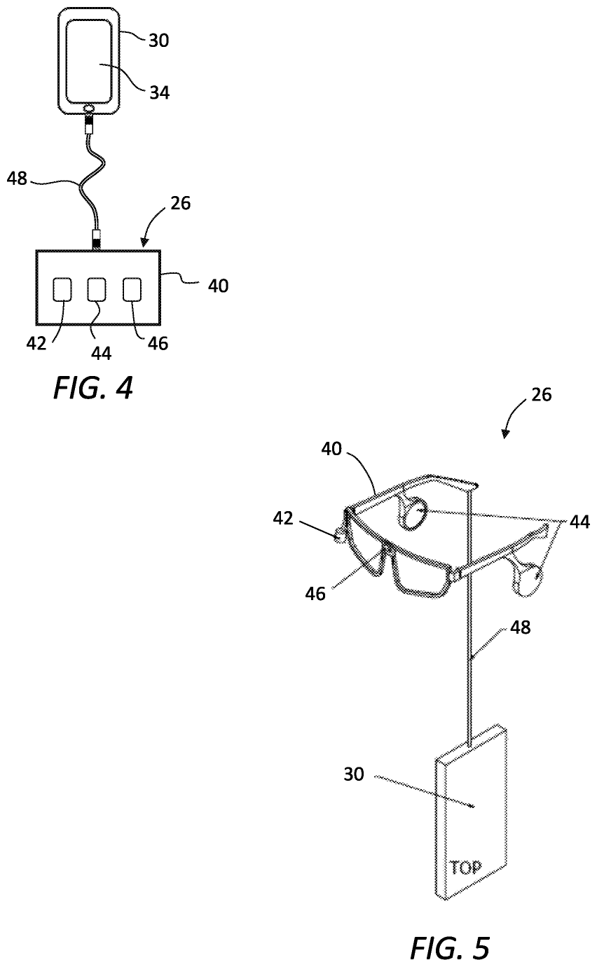

Turning to the first embodiment shown in FIGS. 4 and 5, the mobile AV device 26 includes a support frame 40 that carries one or more microphones 42, one or more speakers 44, and one or more cameras 46 as a self-contained unit that can be easily moved around and carried by a person. However, the support frame 40 does not carry the power source or data transceiver or controls for the microphone, speaker, and camera. Rather, power and remote data communication functions are provided by the battery and internet and/or cellular telecommunications modules of the mobile phone 30. In order to do this, the mobile AV device 26 is operatively coupled to the mobile phone 30 with a power and data cable 48 (“wiring harness”) that allows power from the phone's battery to be provided to the electrical components on the mobile AV device 26 as well as provide data communication between the AV components on the mobile AV device and the control software app on the mobile phone.

FIG. 5 illustrates an example form of the embodiment of FIG. 4 in which the mobile AV device 26 is a wearable device in the form of a pair of eyeglasses (eyeglass frames either with or without any actual lenses). In this nonlimiting example, the eyeglasses have eyeglasses frames 40 configured to rest on the user's nose with earpieces that wrap around opposite sides of the user's head and rest on top of the user's ears in the typical manner. A pair of speakers 44 are carried on the earpieces and situated so as to be situated adjacent to the user's ears when being worn. A front facing camera 46 is carried on the glasses frame so as to capture video from the point of view (POV) of the user when wearing the eyeglasses. The microphone 42 is carried by the eyeglasses frames 40 in a location designed to pick up the user's voice and/or other sounds near the user while the mobile AV device 26 is being worn by the user 24. The power and data cable 48 plugs into a first port carried on the eyeglass frames 40 and a second port in the mobile telephone 30 to provide electrical power and data communication between the mobile AV device 26 and the mobile telephone. In this configuration, the mobile AV device 26 eyeglasses frames 40 can be worn by the user while the phone 30 can be stored someplace else, such as in a pants or shirt pocket. This configuration provides the advantage of omitting the weight of the battery and data transceiver components from the wearable frame, making the eyeglasses form factor more comfortable for wearing.

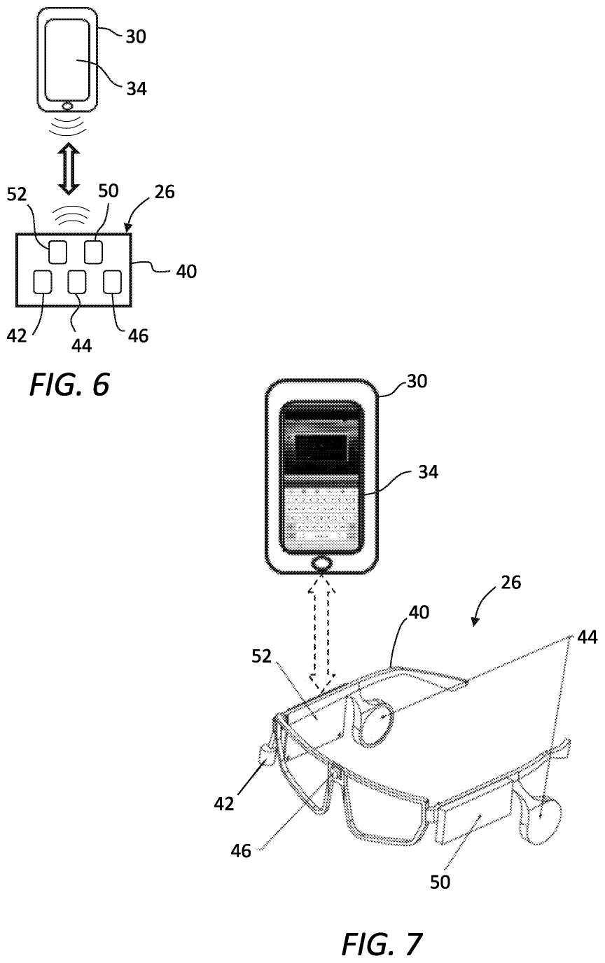

Turning to the second embodiment illustrated in FIGS. 6 and 7, the mobile AV device 26 includes a support frame 40 that carries one or more microphones 42, one or more speakers 44, and one or more cameras 46 similar to the configuration of FIG. 4, as well as a battery 50 and a wireless data transceiver 52, as a self-contained mobile unit. In this embodiment, power for the components of the mobile AV device 26 is provided by the on-board battery 50 rather than from the mobile phone 30. In one preferred configuration, the wireless data transceiver 52 forms a wireless datalink with the mobile phone 30, for example using Wi-Fi or Bluetooth protocols, to connect the control software app on the mobile phone 30 with the AV components 42-46 carried on the mobile AV device 26. The mobile phone 30 also links to the software application 36 via an internet and/or cellular telecommunications network 32 connection. In some configurations, the wireless data transceiver 52 may be configured to connect directly to an internet portal via the Wi-Fi or Bluetooth transceiver. Optionally, the wireless data transceiver 52 may include cellular telecommunications components to allow the mobile AV device 26 to communicate directly with the cellular telecommunications network 32 rather than through the mobile phone 30.

FIG. 7 illustrates an example form of the embodiment of FIG. 6, in which the mobile AV device 26 is a wearable device in the form of a pair of eyeglasses. In this nonlimiting example, the wearable mobile AV device 26 has an eyeglasses frame 40 that carries a pair of speakers 44, a front facing POV camera 46, and a microphone 42 similar as before. In addition, a battery 50 is carried on the left earpiece of the eyeglasses frame 40, and the wireless data transceiver circuits 52 are carried by the right earpiece of the eyeglasses frame. The microphone 42, speakers 44, and camera 46, and transceiver circuits 52 are operatively connected to the battery 50 and each other to provide appropriate electrical power and data communication between the components. The control software app on the mobile phone 30 can be used to control the microphone 42, speaker 44, and camera 46 on the wearable mobile AV device 26 as well as to control the user's account on the remote software application 36, as described previously. However, in this configuration, the mobile AV device 26 eyeglasses frames 40 can be worn by the user 24 while the phone 30 can be stored someplace else, such as in a pants or shirt pocket, but there is no cord or cable 48 connecting the wearable mobile AV device 26 to the phone 30. This configuration provides the advantage of eliminating the cord 48 that could get in the way of various activities and movements of the user 24 during a videoconference session.

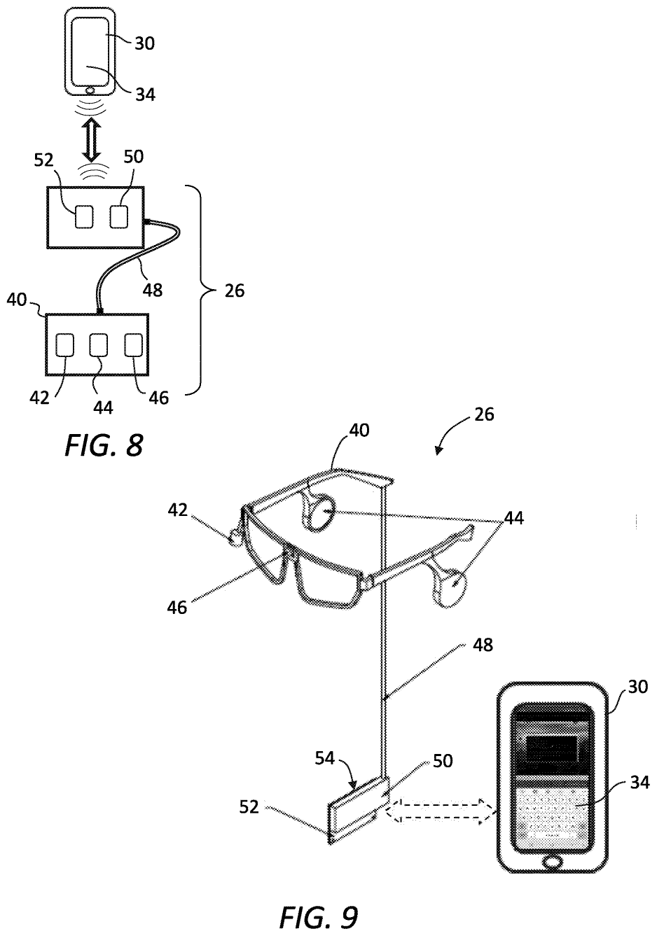

Turning to the third embodiment shown in FIGS. 8 and 9, the mobile AV device 26 includes a support frame 40 that carries one or more microphones 42, one or more speakers 44, and one or more cameras 46 as a single easily portable unit, generally similar to the configuration of FIG. 4. In this embodiment, however, power for the components of the mobile AV device 26 and wireless data communication are provided by a battery 50 and wireless data transceiver 52 carried on a power pack 54 that is separate from the support frame 40 for the AV components. The AV components on the frame 40 are operatively coupled to the power pack 54 with a power and data cable 48 that allows power from the battery 50 to be provided to the electrical components on the mobile AV device 26 as well as provide data communication between the AV components on the mobile AV device and the wireless data transceiver 52 on the power pack 54. In one preferred configuration, the wireless data transceiver 52 forms a wireless datalink with the mobile phone 30, for example by Wi-Fi or Bluetooth protocols, to connect the control software app on the mobile phone 30 with the AV components 42-46 carried on the mobile AV device 26. The mobile phone 30 also links to the software application 36 via an internet and/or cellular telecommunications network 32 connection to send the AV data stream to the host software application 36. In some configurations, the wireless data transceiver 52 may be configured to connect directly to an internet portal via the Wi-Fi or Bluetooth transceiver.

FIG. 9 illustrates an example form of the embodiment of FIG. 8, in which the mobile AV device 26 is a wearable device in the form of a pair of eyeglasses. In this nonlimiting example, the wearable mobile AV device 26 has an eyeglasses frame 40 that carries a pair of speakers 44, a front facing POV camera 46, and a microphone 42 similar as before. The battery 50, and the wireless data transceiver 52 are carried on the separate power pack 54, which could be carried in the user's pockets for example to remove the weight of those components from the eyeglasses frame 40. The power and data cable 48 connects to a first port carried by the eyeglasses frame 40 and a second port on the power pack 54 to provide power to the AV components 42-46 on the eyeglasses frame and data communication between the AV components and the wireless data transceiver 52. The control software app on the mobile phone 30 can be used to control the microphone 42, speaker 44, and camera 46 on the wearable mobile AV device 26 as well as to control the user's account on the remote software application 36, as described previously. This configuration provides the advantage of removing the weight of the battery 50 and the wireless data transceiver 52 from the eyeglass frames 40, thereby making the wearable mobile AV device 26 more comfortable for the user 24 to wear during a videoconferencing session.

FIGS. 12A and 12B illustrates an optional arrangement in which the mobile AV device 26 in the form of a wearable mobile AV device 26, such as the eyeglasses form in FIGS. 5, 7, or 9, may also include a display system that is separate from the phone/computer. For example, the eyeglasses frame 40 may carry a heads-up display system 56 that includes a video projection system that can project a heads-up display to provide an augmented reality or even virtual reality display to the user 24 wearing the mobile AV device 26. The addition of an optional heads-up display system 56 (screen display) to the eyeglasses frames 40 can provide more immersion while using the wearable mobile AV device 26. The video feed from the front facing camera 46 can be displayed on the optional display. This video feed will be live and additional information can be overlayed on the feed, thereby giving the user additional information in their surrounding environment. The user 24 will be able to live stream, conference call, interact with traffic from their phone 30 (e.g., emails and texts), get voice information read to them, and many other forms of interaction with applications on their phone and internet tools on the wearable mobile AV device 26. In this embodiment, the wearable mobile AV device 26 allows the user wearing it options for communication and numerus tools, such as choosing how to interact with their phone and email traffic, using the internet browser and running functional tools using their phone for keyboard and mouse, and voice controls. In this example, the user can use phone, voice, applications, and other controls to interact with the wearable mobile AV device 26 in their environment.

In some optional arrangements, the mobile telecommunications device 30 in any one of the embodiments described above could be replaced by a personal computer, such as a laptop or desktop computer, which is directly connected to the internet and running the control software app. The direct internet connection allows for communication between the mobile AV device 26 and the host software application 36 in the cloud. The control software app allows the user 24 (or another person, such as an assistant or producer) to control the various AV components 42-46 as well as the user's account on the software application 36 directly from the personal computer. This configuration could make it easier and/or more comfortable for the user 24 to manipulate the control software app on the larger screen of the larger computer then using the control software app on the smaller screen of the mobile telephone 30.

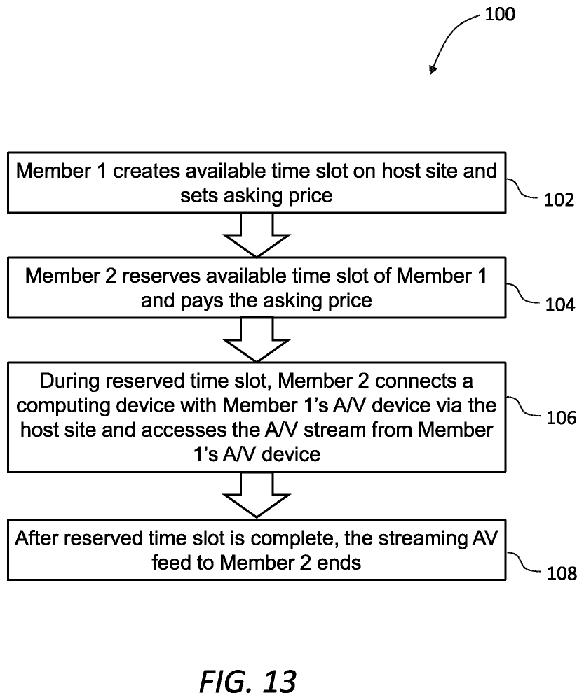

Turning now to FIG. 13, a nonlimiting example method of using the videoconferencing system 20 between two members is illustrated. In this method, it is assumed that both the user 24 and the observer 22 have created individual member accounts on the software application 36 to allow for payments, scheduling, and other administrative matters relative to the scheduling, execution, and payment for videoconference sessions. Typically, the observer member's account is typically linked to a funding source, such as a bank account or credit card, to be able to pay for time slots reserved with the user member. Similarly, the user member's account is typically linked to a different bank account or similar funds receiving account to be able to receive payments for completed time slots with an observer. While this example assumes that the user 24 is offering a time slot and the observer 22 is purchasing the time slot, it is also possible that the observer 22 could be offering the time slot and the user 24 could be purchasing the time slot.

With the various member accounts thus set up, at 102 the user 24 enters the software application 36 and selects one or more predefined time slots during which he/she is willing to conduct videoconference sessions with one or more observers 22. The member user 24 also sets a price for the videoconference sessions, and may provide a description of the experience and/or services to be offered during the videoconference sessions. The predefined time slots, associated pricing, and services offered are then published and/or available to the observers with accounts on the software application 36. The user 24 may enter and control the software application 36 from the control software app on the mobile telecommunications device 30 or from a different internet-connected computer. Preferably, the user's interface with the host software application 36 is through an internet browser, but a dedicated user interface program could be implemented.

At 104, the member observer 22 searches for a user's posted available time slots and selects one or more of the posted available time slots of the user 24 and pays the set price for the selected time slot(s) in order to reserve the time slot(s). Upon reserving and paying for the time slot, the set price is automatically deducted from the observer's account and credited to the user's account. In preferred embodiments, after satisfactory completion of a videoconferencing session during a reserved time slot, the user 24 can request the website to transfer the funds that were deposited into their account to their personal banking account. Alternatively, the website may allow the user 24 to receive payment as soon as the time slot for a videoconferencing session has been reserved, thereby ensuring that the user 24 receives payment as soon as the observer 22 purchases and reserves a given time slot and eliminating the risk of the observer later canceling a reserved time slot and the user not receiving payment therefor. In other configurations, the transfer of payment of the set price may occur at later times, such as at the beginning of a reserved time slot videoconference session.

At 106, during the reserved time slot, the observer 22 connects to the software application 36 in the cloud, for example through the user's AV device 28, such as a personal computer or a smart phone, to access the live audiovisual stream from the user's account coming from the mobile AV device 26. At the same time, the user 24 transmits video and/or audio data from the mobile AV device 26 to the user's member account on the host software application 36 in the cloud. Once connected, the observer 22 can see and/or hear the video and/or audio coming from the user's mobile AV device 26. As an example, a wearable mobile AV device 26 in the form of a pair of eyeglasses as described herein before, can provide a live video stream from the point of view the user 24 wearing the eyeglasses and can hear the voice and/or other nearby sounds from the user. If the user 24 has selected to enable bidirectional audio communication with the observer 22, the observer 22 can also speak to the user through the speakers 44 on the mobile AV device 26, thereby engaging in a real-time two-way conversation with the user while also seeing and hearing what the user is seeing and hearing. This may allow, for example, an experienced person as the observer 22 to see what a less experienced person as the user 24 sees and is doing, and to hold a conversation with the user to critique, guide, or comment on the user's actions, in real time. This could provide the ability for remote teaching or mentoring or oversight by the more experienced person while the less experienced person is actually performing some given action. Alternatively, if the user 24 does not allow the observer to transmit audio back to the user's speakers 44, the system could be used for example by a performing artist to allow the observer to experience a performance from the point of view of the artist without the artist being interrupted by audio from the observer(s) 22. Of course, an essentially unlimited number of other use scenarios are also possible.

At 108, when the reserved time slot has elapsed, the videoconference session ends and the audio-visual video stream to the observer 22 ends. The streaming can be ended automatically by the host site's software application 36, and/or the streaming can be ended manually by either the user 24 or the observer 22.

In this way, the videoconferencing system 20 allows content producers to connect with potential consumers of the content or with potential providers of instructions, feedback, or guidance, facilitate scheduling of live real-time videoconferencing sessions between the producers and consumers at agreed upon prices, and facilitate automatic payment of the price from the observer to the user (or from the user to the observer), thus ensuring that the user (or observer) receives full payment, regardless of whether the observer (or user) actually shows up for the reserved videoconference session.

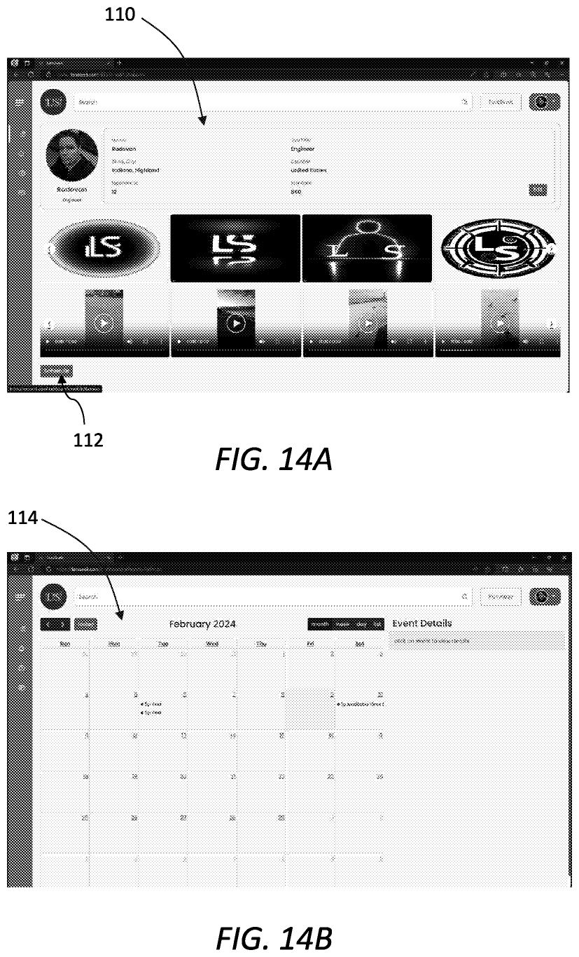

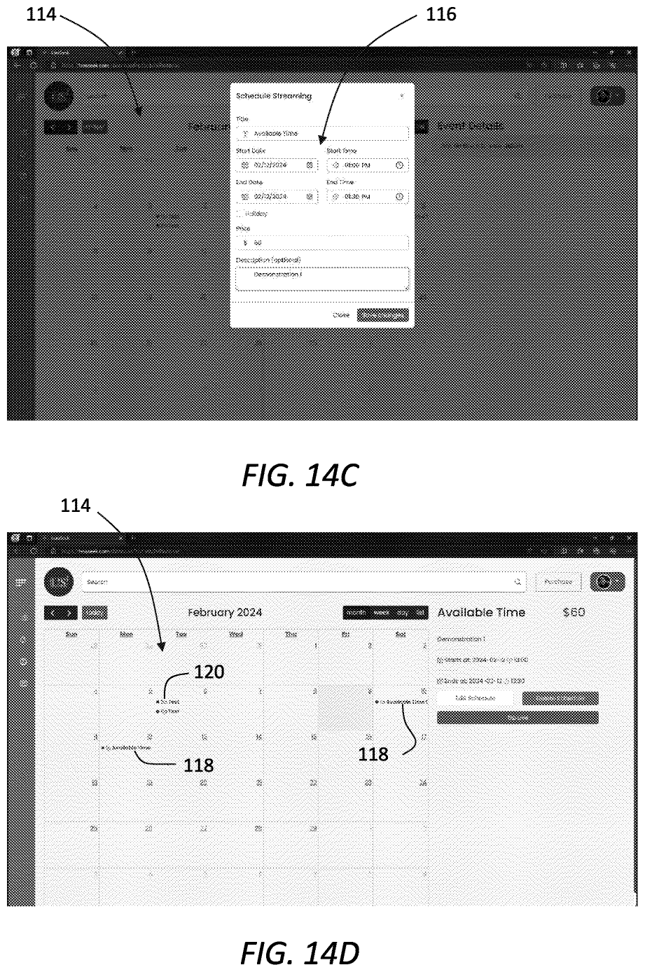

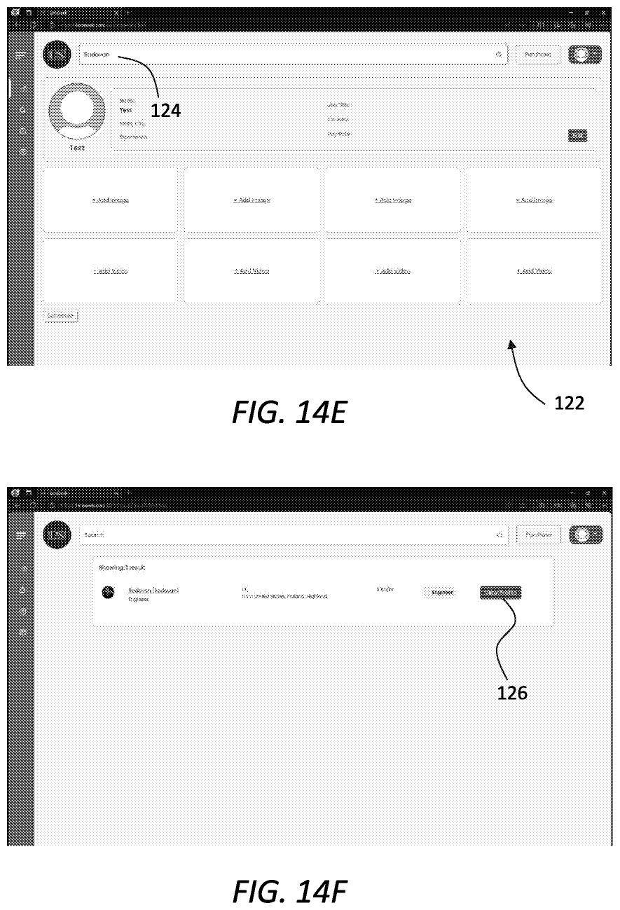

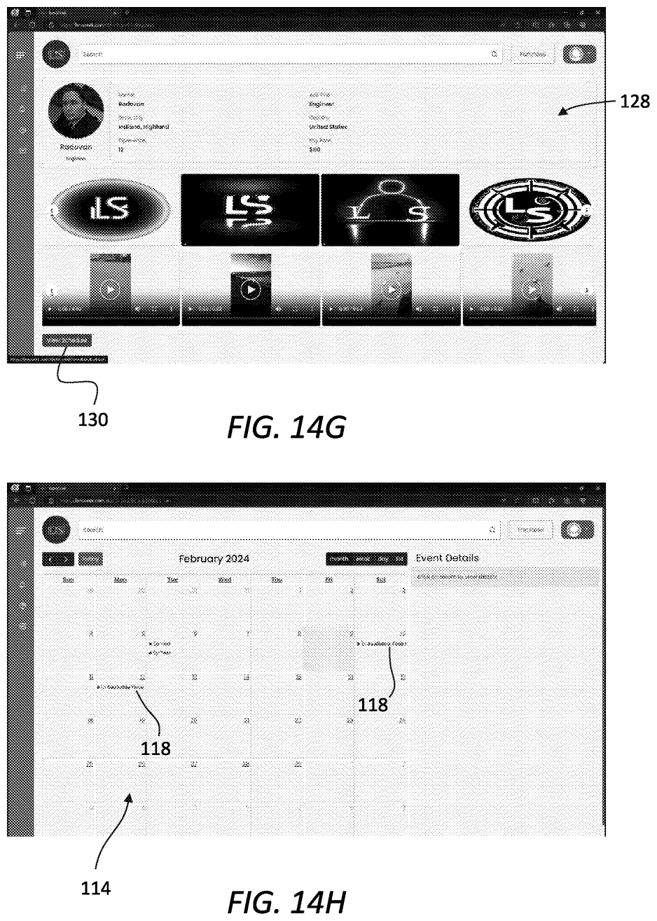

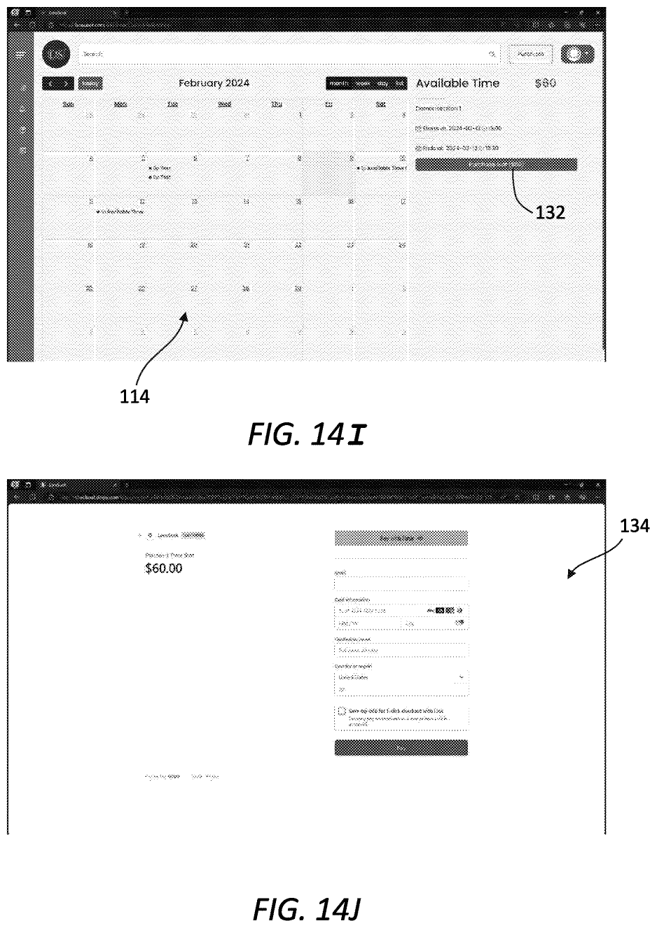

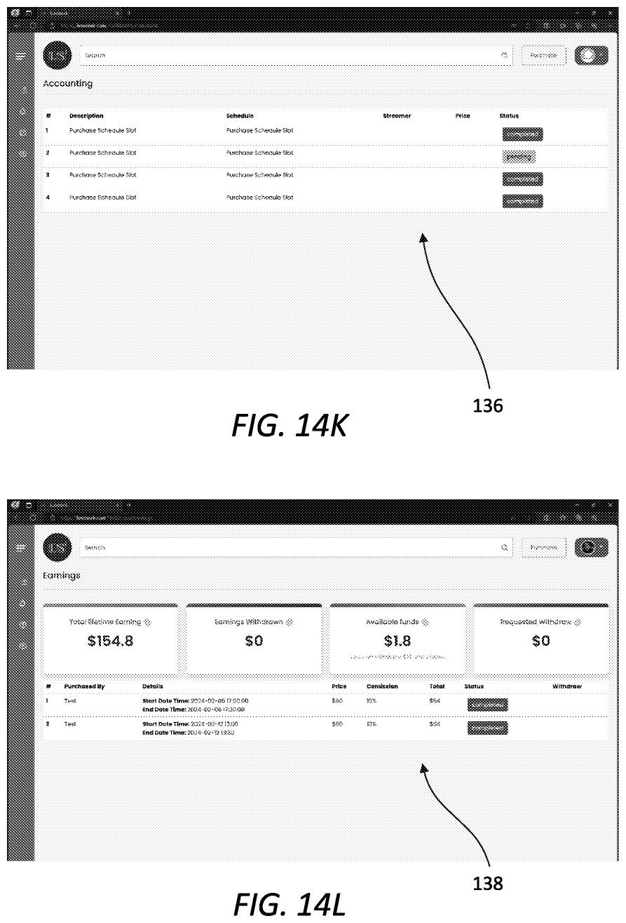

FIGS. 14A-14L provide a nonlimiting example of a specific use scenario of the videoconferencing system 20 according to the method 100 illustrating steps and incentives for using the method. This example illustrates how members who sign up for a service can connect with each other. This method of connection can be used with any smart computer device, such as a smart phone, laptop, tablet, and the mobile AV device on either side of the communication. This method is not limited to use on the video conferencing system 20. Rather, this method of connecting users can be applied to any platform or service capable of providing live bi-directional audio-visual data streaming between two remote computers. Using this method and these steps could be implemented in many diverse industries and use scenarios. This scenario illustrates various options, incentives, scheduling, and other features for members to connect using the video conferencing system 20. In the initial setup, members can create their respective accounts and be an identified (known) member, or choose to remain anonymous to the rest of the members, i.e., not submit personal information such as phone number, email address, etc. An identified member can be searched and have profile information that can be viewed by other members, whereas an anonymous member is not generally searchable or has profile information that can be viewed by other members. An anonymous member can obtain a membership that enables the anonymous member to call other members and/or be called by other members.

In this example, two members create a connection on the software application 36 as accessed through an internet website on a browser program between a known member “Radovan,” who is a user setting and offering availability for sale, and an anonymous member “Test,” who is an observer who wants to connect with Radovan. Either member can have the capacity of the user 24 with the mobile AV device 26 or of the observer 22, the only differentiation being what services are being offered (or requested) by the member Radovan. FIGS. 14A-14D show what Radovan, in this example as the user, does to post his availability to other members. As shown in FIG. 14A, to start, Radovan navigates to his private-facing profile page 110 for his account on the application 36 using a web browser and clicks on the schedule button 112. Radovan is then directed to his schedule page 114, as shown in FIG. 14B. On the schedule page, Radovan creates time slots indicating his availability for videoconferencing sessions in the future using a scheduling function 116, as shown in FIG. 14C. Radovan chooses the day, time, and length of the available time slot being offered. The scheduling function 116 also prompts Radovan to choose a title, set a price, and a provide a description of the services being offered or requested during the available time slot. Radovan then saves the changes made to his calendar. Once saved, the information about the available time slot 118 is posted in the host software application such that all members can then search for and view Radovan's schedule and the details of Radovan's available time slot, and are able to choose his available slots. Once posted, Radovan waits for any other member to choose his available time slot(s). If and when another member chooses the available time slot, Radovan receives a notification from the software application, for example by an email and/or an alert on his mobile telephone 30 or other computer. As shown in FIG. 14D, Radovan is able to check his schedule and click on slots to see what time slots 120 have been reserved by other users (“reserved time slots”) and information about the users that have reserved the time slots. Radovan is then able to edit, delete, and go live as needed. This is enough for Radovan to set up the available time slots on his end.

FIGS. 14E-14J shows what the member, “Test” (the observer in this example), does to select an available time slot with “Radovan.” As shown in FIG. 14E, Test logs into to their account and navigates to the profile page 122 associated with their account. Test then searches for member Radovan using the search bar 124 at the top of the profile page 122. In this example, member Test has chosen to remain anonymous so as not to be generally visible to other members. However, Test can optionally choose various information to share on their profile page, such as pictures, videos, and/or personal or professional details. After clicking on the search button, Test finds a link to Radovan's profile page, as shown in FIG. 14F. To view Radovan's profile page, Test clicks on the View Profile button 126, which directs Test to member Radovan's public-facing profile page 128, as seen in FIG. 14G, where Test can view personal information, photos, video, and/or other content that Radovan has posted to his profile page. The public-facing profile page 128 displays different functionalities than the private-facing profile page 110, in that the private-facing profile page 110 allows only Radovan to edit the content of his profile page and his calendar, whereas the public-facing profile page only allows the viewer to view certain content without the ability to edit it, as well as link to Radovan's calendar. To view Radovan's availability, Test clicks the View Schedule button 130, which send Test to Radovan's schedule page 114, as shown in FIG. 14H, where Radovan's available time slots 118 are visible. As shown in FIG. 14I, to reserve an available time slot on the 12th, Test selects the time slot 118 that Radovan created on the 12th by clicking the time slot, which then shows a display with information about the time slot, the cost set by Radovan, and a Purchase Slot button 132. Clicking the Purchase Slot button 132 directs Test to a payment page 134, as shown in FIG. 14J, which provides a payment method link for Test to input payment information to pay to reserve the time slot. To reserve the selected available time slot with Radovan, Test populates the credit card information to purchase Radovan's time slot, which ensures that Test will have a scheduled, dedicated, and monetized live videoconference session with Radovan at the appointed time of the time slot. After Test's payment has been received, Test will be able to connect to Radovan at the scheduled time using the video conferencing system 20 as described previously. The members Test and Radovan can then complete the meeting for this purchased and reserved time slot using the video conferencing system 20 as described previously.

While the foregoing example scenario described the process for setting up and completing a one-on-one video conference call, the user 24 can optionally set up the video conferencing system 20 to connect with multiple observers 22 in any selected per time slot. Members have a comment window added to text in details as desired.

The host software application 36 may also optionally incorporate additional tools to aid in these communications. For example, the software application 36 could host AI auditing to aid the members during conversations. AI video auditing may optionally be used to aid with environmental tools to help members. The video conferencing system 20 may be configured to allow the users to use different types of hardware for the video conference calls.

The host software application 36 also includes appropriate accounting modules to allow the video conferencing system 20 to facilitate transfer of payments to and from the members of the platform. Thus, in addition to the various profile and scheduling pages described above, every member also has accounting, earnings, and withdraws web pages. FIGS. 14K and 14L relate to these accounting pages. The video conferencing system 20 preferably accepts a variety of payment methods, such credit cards and other types of third-party electronic payment systems, and/or crypto currency payments.

Continuing with the example scenario, after successful completion of the meeting between Radovan and Test during the reserved time slot, both members will be able to go to their respective accounting pages to view their statuses. FIG. 14K shows Test's payment and status page 136. Test's payment and status page 136 shows that the status of reserved time slot is complete and that that Test has paid for the meeting. The payment status on the accounting page relates to the payments between the host of the video conferencing system 20 and the software application 36 and the members, not the status between members, because the host acts as a financial intermediary between the members. Thus, for example, a “pending” status indicates that a member submits to the platform host that they generated money and are requesting it sent to their personal payment method. For example, the member requests the platform host to send revenue generated to their bank account or other accounts. A “complete” status indicates that the platform host verifies money in the member's account and sends the funds to the member's designated third-party banking (or similar) institution. When the funds arrive in the member's personal payment method, then the status changes to complete.

FIG. 14L shows another accounting web page 138 that provides historical payments and transactions information for an account holder. FIG. 14J shows earnings that Radovan's account has generated from meetings with all members.

As previously noted above, though the foregoing detailed description describes certain aspects of one or more particular embodiments of the invention, alternatives could be adopted by one skilled in the art. For example, the system 20 and its components could differ in appearance and construction from the embodiments described herein and shown in the drawings, functions of certain components of the system could be performed by components of different construction but capable of a similar (though not necessarily equivalent) function, and various materials could be used in the fabrication of the system and/or its components. As such, and again as was previously noted, it should be understood that the invention is not necessarily limited to any particular embodiment described herein or illustrated in the drawings.

1. A system of live-streaming video and audio, the system comprising:
a mobile audio-visual (AV) device comprising:
a frame;
a camera carried by the frame;
a microphone carried by the frame; and
a speaker carried by the frame; and
a data communication link for connecting the camera, microphone, and speaker with a mobile telecommunications device;
wherein the data communication link transmits user audio data and user video data captured by the camera and the microphone to the mobile telecommunications device; and
wherein the data communication link transmits observer audio data from the mobile telecommunications device to the speaker.

2. The system of claim 1, wherein the mobile AV device is a wearable device configured to be worn by a person.

3. The system of claim 2, wherein the mobile AV device comprises an eyeglasses frame, wherein the camera, the microphone, and the speaker are carried by the eyeglasses frames.

4. The system of claim 1, wherein the data communication link is wired connection comprising a power and data cable connecting the mobile AV device to the mobile telecommunications device.

5. The system of claim 4, wherein the electric power for the camera, microphone, and speaker are supplied over the wired connection from a battery of the mobile telecommunications device.

6. The system of claim 1, wherein the data communication link is a wireless data link.

7. The system of claim 6, wherein the mobile AV device further comprises a battery carried by the frame for providing electrical power to the camera, the microphone, and the speaker.

8. The system of claim 6, wherein the data communication link comprises a data transceiver carried by the frame.

9. The system of claim 6, wherein the mobile AV device further comprises:
a battery pack that is separate from the frame of the mobile AV device, the battery pack comprising a battery and the data communication link, the data communication link comprising a wireless data transceiver for data communication with the mobile telecommunications device; and
a wired connection comprising a power and data cable operatively connecting the mobile AV device to the battery pack to provide electric power from the battery to the camera, the microphone, and the speaker and provide data communication between the data communication link and the camera, the microphone, and the speaker.

10. The system of claim 6, wherein the wireless data link comprises at least one of a Wi-Fi transceiver, Bluetooth transceiver, infrared transceiver, and a radio frequency transceiver.

11. The system of claim 1, wherein the mobile AV device further comprises a heads-up display system.

12. The system of claim 1, wherein the mobile telecommunications device comprises at least one of a mobile telephone, a smartphone, a tablet computer, and a laptop computer, wherein the mobile telecommunications device is configured to transmit and receive data via at least one of a cellular telecommunications network and an internet network.

13. The system of claim 1, further comprising:
a mobile computer program application stored in a non-transitory form in a digital memory for execution on a processor of the mobile telecommunication device to, the mobile computer program application comprising instructions configured to cause the mobile telecommunication device to:
connect and/or disconnect the mobile telecommunication device from the camera, the microphone, and/or the speaker via the data communication link;
transmit the user audio data and the user video data from the mobile telecommunications device to a remote observer via a data communications network;
receive observer audio data from the remote observer via the data communications network; and
transmit the received observer audio data to the speaker in the mobile AV device via the data communication link.

14. The system of claim 1, further comprising:
a host computer program application stored in a non-transitory form in a digital memory for execution on a digital processor system remote from the mobile telecommunications device and the mobile AV device, the host computer program application comprising instructions configured to cause the second digital processor system to:
store a user profile representative of characteristics associated with the user in a user profile database;
allow the user to create a time slot during the user will be available for a videoconferencing session and set an asking price for reserving the time slot;
store an observer profile representative of characteristics associated with the observer in an observer profile database;
allow the observer to select the user's time slot and reserve the time slot for the streaming videoconferencing session with the user by paying an asking price for the time slot prior; and
after the time slot has been reserved, establishing the streaming videoconference session between the mobile AV device and an observer AV device via the telecommunications system during the reserved time slot.

15. The system of claim 14, wherein the host computer program application further comprises instructions configured to cause the digital processor system to require a monetary payment from an observer account associated with the observer profile to a user account associated with the user profile before the observer can establish the streaming videoconference session.

16. A method of live-streaming video and audio data between a first member and a second member, the method comprising:
the first member creating an available time slot on a host site and setting an asking price for the available time slot;
the second member selecting the available time slot on the host site and paying the asking price to reserve the time slot;
during the reserved time slot, establishing a streaming videoconference session between a mobile AV device associated with one of the first and second members as a user and a second AV device associated with the other of the first and second members as an observer via the host site; and
when the reserved time slot is complete, ending the streaming videoconference session.

17. The method of claim 16, wherein the mobile AV device comprises a frame, a camera carried by the frame, a microphone carried by the frame, and a speaker carried by the frame, and a data communication link for connecting the camera, microphone, and speaker with a mobile telecommunications device, wherein the data communication link transmits user audio data and user video data captured by the camera and the microphone to the mobile telecommunications device, wherein the data communication link transmits observer audio data from the mobile telecommunications device to the speaker, and wherein the mobile telecommunications device provides wireless data communication with the host site.

18. The method of claim 16, wherein the user is a student and the observer is a teacher.

19. The method of claim 16, wherein the user is a content provider and the observer is a content consumer.
